(19) United States
(12) Patent Application Publication
(10) Pub. No.: US 2007/0211248 A1
(43) Pub. Date: Sep. 13, 2007

(54) ADVANCED PATTERN RECOGNITION SYSTEMS FOR SPECTRAL ANALYSIS

(75) Inventors: H.J. Caulfield, Cornersville, TN (US); David L. Frank, Boca Raton, FL (US); Jamie L. Seter, Deerfield Beach, FL (US)

Correspondence Address: FLEIT, KAIN, GIBBONS, GUTMAN, BONGINI;& BIANCO P.L., ONE BOCA COMMERCE CENTER, 551 NORTHWEST 77TH STREET, SUITE 111, BOCA RATON, FL, 33487, US

(73) Assignee: Innovative American Technology, Inc., Boca Raton, FL (US)

(21) Appl. No.: 11/624,121

(22) Filed: Jan. 17, 2007

Related U.S. Application Data
(60) Provisional application No. 60/759,331, filed on Jan. 17, 2006.

(51) Int. Cl. G01J 3/44

(52) U.S. Cl. 356/301

(57) ABSTRACT

A process of rapid and highly accurate analysis of spectral data, includes both a linear scanning (LINSCAN) method and an advanced peak detection method for pattern recognition. One or both of the methods are used to support the detection and identification of chemical, biological, radiation, nuclear and explosive materials. The spectra of various targets can be analyzed by the two spectral analysis methods. These two methods can be combined for dual confirmation, greater accuracy, and to reduced false positives and false negatives, relative to what can be accomplished by either alone.

### CROSS REFERENCE TO RELATED APPLICATIONS

This application is based on, and claims priority from prior co-pending U.S. Provisional Patent Application No. 60/759,331, filed on Jan. 17, 2006, the entire teachings thereof being hereby incorporated by reference.

### FIELD OF THE INVENTION

This invention generally relates to systems and methods for detection and identification of hazardous target materials including chemical, biological, radiological, nuclear, and explosive materials, and is more particularly related to a system and method for detection and identification of target materials by analyzing complex spectra for chemical, biological, radiological, nuclear and explosive materials, or any other types of target search using spectra (e.g., signal-vs-energy, signal-vs-wavelength, etc.).

### DESCRIPTION OF RELATED ART

Current attempts at analyzing complex spectra for chemical, biological, radiological, nuclear and explosive materials or any other types of target search using spectra (signal-vs-energy, signal-vs-wavelength, etc.) do not enable the rapid and highly accurate detection, identification and/or quantification for trace amounts required in a variety of applications such as homeland security and biological testing. While many pattern recognition systems can perform identification given sufficient and refined data in a laboratory environment, the ability to perform in a complex environment with a wide variety of spectral interferences is a challenge. Examples of the current problems are the detection, identification and verification of radiological materials present in cargo and the ability to differentiate between the normally occurring radiological materials (NORM) that are present, including the cargo on the manifest and hazardous or illegal radiological cargo. Another example is the ability to detect and identify biological threats such as where a minute trace amount could be deadly.

Therefore a need exists to overcome the problems with the prior art as discussed above.

### SUMMARY OF THE INVENTION

To achieve rapid and highly accurate analysis of spectral data, both a linear scanning (LINSCAN) method and an advanced peak detection method for pattern recognition are provided herein. One or both of the pattern recognition processes are used in a system, according to alternative embodiments of the invention, to support the detection and identification of chemical, biological, radiation, nuclear, and explosive materials wherever possible. The spectra are very different for these various targets (most commonly infrared for chemical and biological) and gamma ray for radiological targets. Alternative embodiments of the invention apply one or more of these processes to analyze any spectrum, whatever, e.g. ultrasound.

According to one embodiment of the invention, the two spectral analysis methods are combined for dual confirmation, greater accuracy and to reduce false positives and false negatives, relative to what can be accomplished by either method alone.

The use of these pattern recognition methods suggests also using autocorrelation and cross-correlation of spectra. The spectra used should represent the target materials and the expected background (white and colored). In the LINSCAN method, those spectra themselves (preferably including the expected white and colored noise spectra) are simply vectors of nonnegative numbers (one for each spectral bin measured)—in some hyperspace. Those vectors can be readily orthonormalized. That is, a new pseudospectrum (with real—positive or negative) values for each bin for each material and both types of background can be computed before hand whose cross correlations with the expected spectra of all other gamma ray spectra are zero. Correlating the measured spectrum with the pseudospectrum will produce a number that should be proportional to the amount of the target material present. An Advanced Peak Detection method (APD) provides a separate method for spectral analysis and can be used to verify the results of LINSCAN.

In another embodiment, the first method deployed can be focused on reducing the false negative results while the second method deployed further reduces the false positive results, thereby providing a greatly reduces overall false positive an false negative response.

In certain applications, the spectra provided for the detection, identification and or quantification of chemical, biological, radiological, nuclear and explosive materials are derived from a complex combination of target materials (members of a list of materials deemed interesting,) background noise of unknown origin, and other materials not on a list of interesting materials.

Furthermore, in some cases such as isotope (radiological) detection and identification, physical objects such as crates or trucks can absorb background radiation that would have been detected had those objects not been present. As an example of the use of the pattern recognition methods of this invention is the detection and identification of gamma ray spectrum to determine which, if any of the target materials is present and the approximate amounts of those materials based on a zero-shielding assumption despite the presence of unknown materials and the background problems just noted. Of course, as the nature and amount of shielding is usually unknown, there may be more radiological material present than these methods (or any other) might indicate.

According to another embodiment of this invention, the detection of the presence or absence of secondary materials is used for identification of target materials. Examples of secondary identification are as follows. For infrared search for anthrax, the identification of a species of anthrax in the presence of trace amounts of chemicals known to be used to weaponize anthrax could differentiate a hazardous material. Another example is the detection of alpha radiation and neutron radiation to provide additional discrimination if and when the identity of materials is not resolved by gamma ray spectrum.

Another embodiment of the invention accomplishes the detection and identification of the target material very rapidly and with affordable computers, ASICs, DSPs, or the like.

Another embodiment of the invention provides a user control over tradeoffs between false positive rate and false negative rate.

### BRIEF DESCRIPTION OF THE DRAWINGS

FIG. 1 provides an illustration of a complex spectrum for isotope detection and identification.

FIG. 2 provides a flow diagram describing a set of processes for use with a LINSCAN method of pattern recognition that is illustrated by analyzing isotope spectra as an example.

FIG. 3 provides a flow diagram illustrating an example of a learning process for the LINSCAN method of pattern recognition, using isotope spectra in the example.

FIG. 4 provides a flow diagram illustrating an example of processes used for the LINSCAN method of pattern recognition, using isotope spectra in the example.

FIG. 5 is a flow diagram illustrating an example of processes used for an Advanced Peak Detection method of pattern recognition, using isotope spectra in the example.

### DETAILED DESCRIPTION

While the specification concludes with claims defining the features of the invention that are regarded as novel, it is believed that the invention will be better understood from a consideration of the following description in conjunction with the drawing figures, in which like reference numerals are carried forward. It is to be understood that the disclosed embodiments are merely exemplary of the invention, which can be embodied in various forms. Therefore, specific functional details disclosed herein are not to be interpreted as limiting, but merely as a basis for the claims and as a representative basis for teaching one of ordinary skill in the art to variously employ the present invention in virtually any appropriately detailed structure. Further, the terms and phrases used herein are not intended to be limiting; but rather, to provide an understandable description of the invention.

Alternative embodiments of the invention utilize various software methods for the analysis of spectral data to detect and identify target materials. A Linear Scanning (LINSCAN) method and an Advanced Peak Detection (APD) method are used by an information processing system. These multiple pattern recognition methods can be used individually or as a combined effort to enable rapid and accurate detection, identification and quantification of chemical, biological, radiation, nuclear and explosives materials for a wide variety of applications.

The use of these pattern recognition methods also can include methods for autocorrelation and cross-correlation of spectra. The spectra used should represent the target materials and the expected background (white and colored).

In the LINSCAN method, those spectra themselves (preferably including the expected white and colored noise spectra) are simply vectors of nonnegative numbers (one for each spectral bin measured)—in some hyperspace. Those vectors can be readily orthonormalized. That is, a new pseudospectrum (with real—positive or negative) values for each bin for each material and both types of background can be computed before hand whose cross correlations with the expected spectra of all other gamma ray spectra are zero. Correlating the measured spectrum with the pseudospectrum will produce a number that should be proportional to the amount of the target material present. An Advanced Peak Detection method (APD) provides a separate method for spectral analysis and can be used to verify the results of LINSCAN. In another embodiment, the first method deployed can be focused on reducing the false negative results while the second method deployed further reduces the false positive results, thereby providing a greatly reduced overall false positive an false negative response.

The examples discussed below will be mostly illustrated with methods for the detection and identification of radiological isotopes, to explain various aspects of the invention. While the examples below illustrate methods used for the detection, identification, and quantification of radiological materials, these same principles could also be applied to chemical, biological, acoustic, nuclear and explosives detection, and any other situation in which targets are to be detected using spectra.

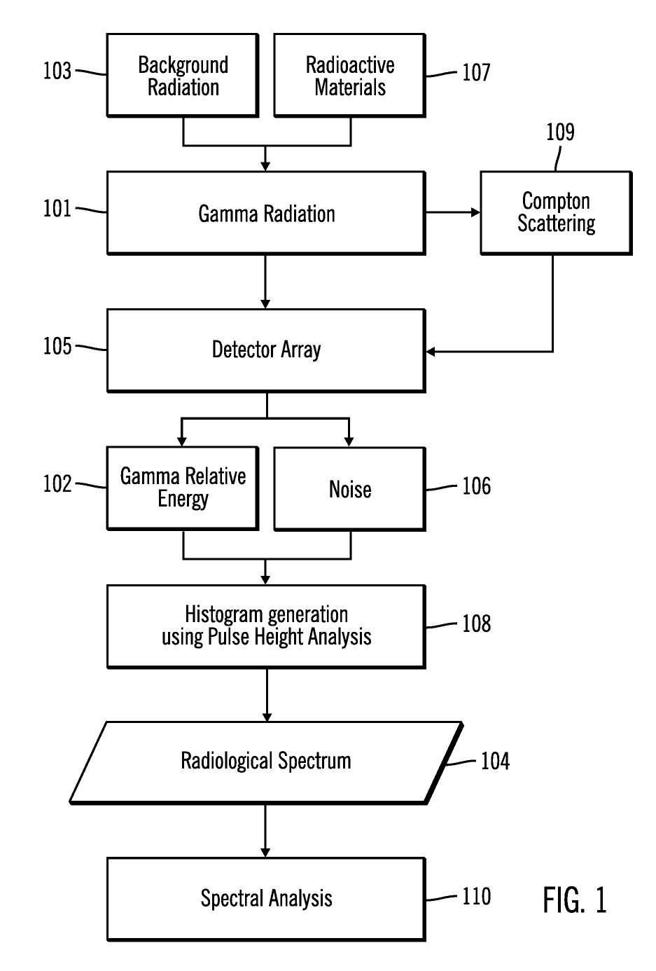

Referring to FIG. 1, a schematic representation of a field environment for Isotope Identification is illustrated as objects and actions. According to an embodiment of the present invention, gamma radiation 101 is measured by detectors or an array of detectors 105 who convert the interaction of gamma rays and the detector into a relative energy 102. The energies are then sorted into a histogram 108 producing a representation as a complex radiological spectrum record 104 for analysis 110 by energy-vs.-intensity probabilities.

The collected spectrum is a sum of physical processes which need to be accounted for in order to deduce the Target Isotopes 107 that may be present. These physical processes include Background 103 Radiation such gamma radiation that would occur in the absence of targets. Gamma rays come from non-target material (sometimes even of the same material as the target) present somewhere. Most of the background comes from nearby material but some can come from space. The background is spatially and temporally variable.

The Target Isotopes randomly decay at a rate governed by a Poisson probability distribution and emit a number of gamma ray photons at predictable energies and probabilities. Also produced in the process are gamma rays scattered by electrons into lower energies—the Compton scattered radiation 109. We assume there is a known set of M isotopes I₁, I₂ . . . I_{M}. Each produces a known gamma ray spectrum on the average. These processes are predictable and can be modeled. Indeed, we assume a computer simulation is available.

The detectors and electronics contribute to the measurement (spectral histogram) errors by introducing natural noise 106 that obscures the exact value of the individual gamma ray photon's energy. For simplicity, we have ignored variability among detector elements, nonlinear detector response, and so forth. We assume instead, that the noise is additive and comprised of two parts - white and colored.

All of these factors contribute to the measured spectrum, but the task is to find what target materials are present in what abundance while ignoring, or at least overcoming, the other contributions.

Complicating factors: There are several other complicating factors including these:

Unpredictability of the Compton scattering pattern. Experimentally, the Compton scattering energy pattern varies with the setup details, the physical environment, etc. This is important, because it can masquerade as signal from other isotopes.
Nonlinear detector response. The easy and often-accurate assumption is that the measured data result from a simple sum of the contributions from all isotopes and all of the other signal sources. If the count rate at some detector is high enough, there can be two detected photons in the integration time causing it to register a photon of twice the energy. Less frequently, it leads to three times the energy. The shot noise is signal dependent. There may well be other nonlinearities associated with the electronics. The electronics converting signals to apparent gamma ray energy are noisy—another effect that can produce different results for the same input.

One embodiment of the present invention provides multiple software analysis methods to use the information from the complex spectra to detect, identify, and quantify target chemical, biological, radiation, nuclear and explosive materials, acoustic, and other spectra.

LINSCAN Method

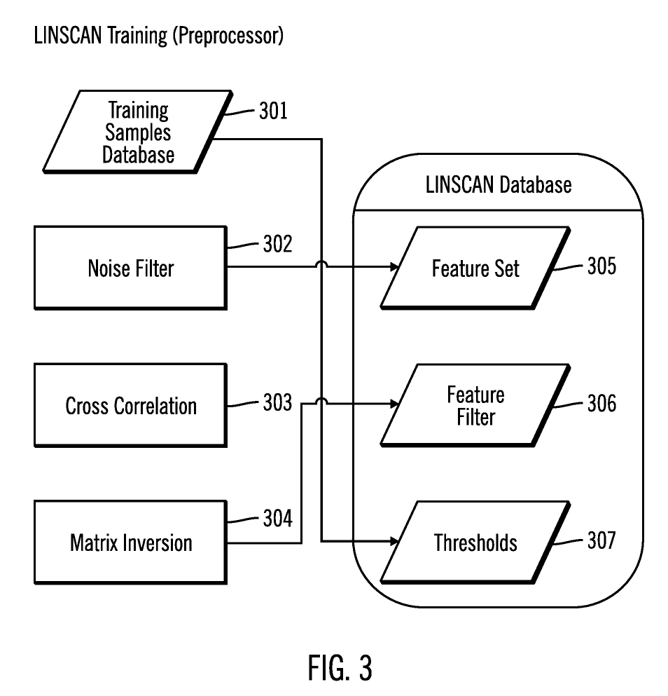

FIG. 3 describes a learning process used for the pattern recognition system to acquire spectra from a known source to establish a comparative database for LINSCAN. A set of spectral images of target isotopes or the materials the system is designed to identify are collected from live samples with the detector hardware or from computer simulations to populate a training samples database 301. The same noise Filter 302 that will be applied in the analysis phase covered later is applied to each training sample to produce a set of samples more identifiable and less random as saved as the Feature Set 305.

Each of these samples in the feature set are cross correlated 303 with all the other samples to produce a relational matrix of correlation that identifies similarities. Matrix inversion 304 on this matrix minimizes the effects of those similarities and quantifies the sum of all identifying features to be a value of 1. This inverse matrix is then saved in the LINSCAN database 308 as the feature filter 306. Thresholds for each pattern are set in the originating database to allow user control of the sensitivity of identification. These thresholds are copied into the LINSCAN database as Thresholds 307.

We recognize that in some cases it may be sufficient to leave out one or more of these steps and that further analysis can be performed on the outputs. This patent explicitly includes and claims those variations.

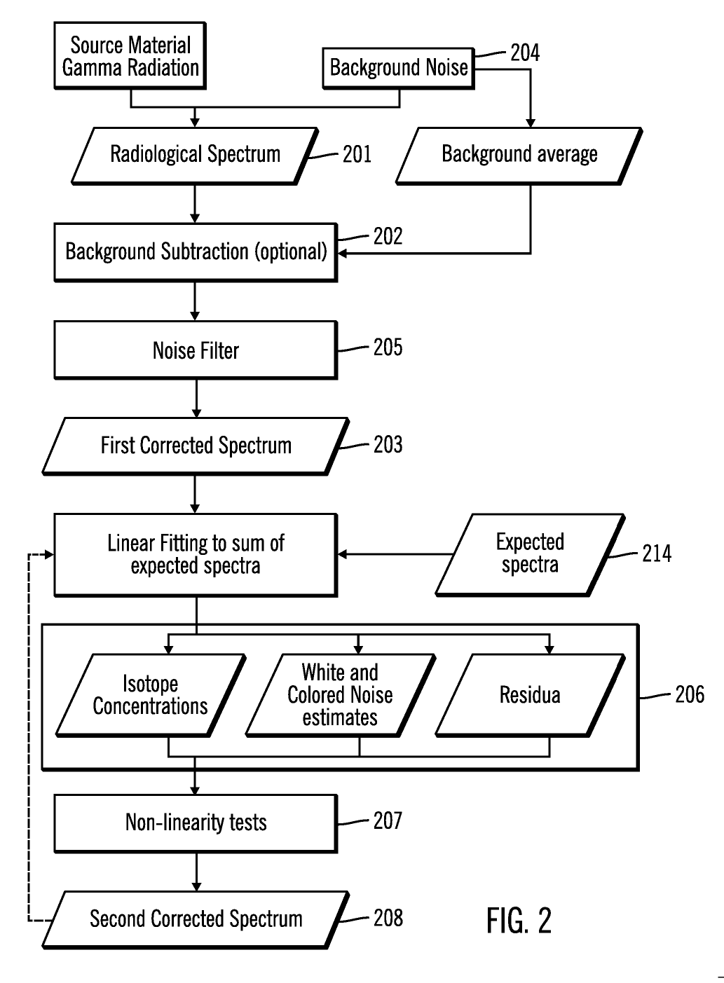

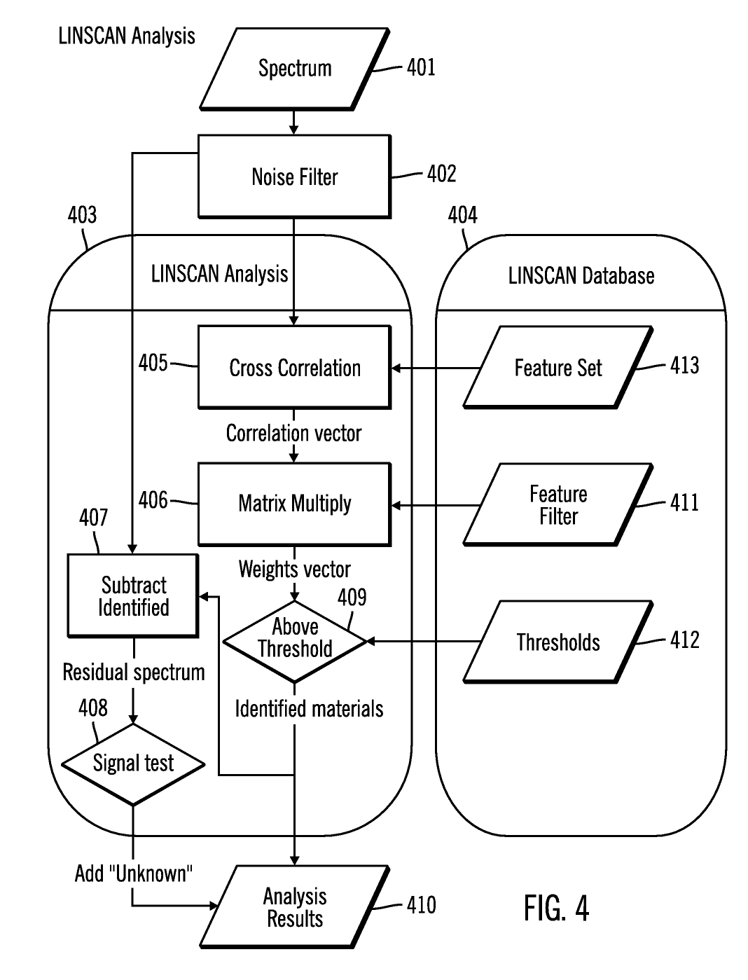

FIGS. 2 and 4 illustrate the overall process and components of spectral analysis as performed by LINSCAN. After collecting a spectrum 201, such as that described in FIG. 1 and related text, the data is preprocessed and normalized by the following methods. If the information is available, background subtraction should be used to reduce background noise 204 in the analysis. Background Subtraction 202 is essential to a good estimation of the non-background content of the signal. There are several ways to do this. You can measure the spectrum in the absence of the target under test at a time close to the analysis time and scale the integration times of each sample, if need be, and subtract. If there is a long time estimate of the expected background it can be cross-correlated with the measured spectrum to determine what weight to assign to the background.

Minimization of Compton Scattering noise 205 is critical, because the noise can be broad and high causing it to mask signals from weak sources and may be misidentified as one or more other isotopes. Our approach is to use some method that emphasizes sharp peaks and deemphasizes broad shapes. There are many ways to do this including unsharp masking, differentiation, convolution based edge enhancement, and so forth. It may also be valuable to smooth the spectrum slightly before doing this—using rank order filtering, convolution, mathematical morphology, Difference Of Gaussians (DOG), ,etc. to reduce the effects of small random variations on the filters calculation.

If necessary, depending on computational hardware costs and constraints, the data is normalized and the scaling factor saved. Normalization is the least important of the preprocessing steps. It is only useful if fixed point operations are used and unneeded if only floating point operations are used. A simple way to normalize is to set the highest value in the spectrum to one (or some other standard value) and scale all the other values by the same factor.

When these things are done, we have the first corrected spectrum 203 which will be referred to as Si (E). We now seek to approximate the formula
S₁(E)=W₁I₁(E)+w₂I₂(E)+. . . +w_{W}W(E)+w_{C}C(E).
Here
wₖ is the weight of isotope Iₖ
Iₖ(E) is the energy spectrum of Iₖ
W(E)=1 stands for the white noise
C(E) is the expected spectrum of the colored noise.
   We can use Gram-Schmidt [e.g. Walter Hoffmann, “Iterative Algorithmen für die Gram-] Schmidt-Orthogonalisierung,” Computing 41, 335=348 (2005)] or Caulfield-Maloney [H. J. Caulfield and W. T. Maloney, “Improved Discrimination in Optical Character Recocinition,” Appl. Opt. 8, 2354 (1969)] orthonormalization. Either will produce a function φⱼ(E) such that the sum of φⱼ(E) S₁(E) over al E channels is wⱼ.

In this way, we can obtain a first estimate of the weights for each component and the two types of noise.

It is sometimes sufficient to stop at this point, but there are other things that can be done.

We can use the expected spectra 214 and the calculated weights 206 to create an indicated spectrum Sₗ(E). We can then calculate an error spectrum
ε(E)=S₁(E)−Sₗ(E).

Ideally ε(E) should zero mean white noise. Any substantial deviation indicates a significant error, such as the appearance of an isotope not in our list.

We can also use the indicated weights to determine if any isotope has enough strength to be liable to cause mistakes due to nonlinear detection 207 and noise effects. If nonlinearity is indicated, we must subtract the spectra expected with the indicated weights in view of the nonlinearity (data determine empirically and preconfigured). The resulting signal is the second corrected spectrum 208. That spectrum can then be analyzed as before.

The remaining task is to determine when to report the presence of some isotope. Sample noise will give at least some nonzero weight for every isotope. If we set the reporting threshold at zero or at some other very low value, we will have too many false alarms. On the other hand, if we set the threshold too high, then we will have too many false negatives. The tradeoff between those two undesirable results can be controlled in various well known ways that are not themselves the subject of this patent.

Our preferred embodiment is as follows:
Collect a spectrum and subtract an estimated background content based on the background measured just before the sample is inserted into the measurement apparatus or over time with a dynamic average to produce a new spectrum 401 of all physical processes introduced at the time a target is acquired,
Apply a noise filter 402 to this spectrum to maximize the signal for analysis such as the filter below
   Smooth with a three-wide window median filter
   Differentiate by multiplying the Fourier transform by E and inverse Fourier transforming that product. Then take the absolute value. This is what we call the spectrum S₁(E)
Compute the weights using Gram-Schmidt method
   Spectrum is cross-correlated 405 with the feature set 413. This identifies similarities between the measured spectrum and the trained spectra.
   Correlation vector is multiplied 406 by the matrix Feature Filter 411 which removes overlapping similarities within the training spectra and scales the sum of identifying differences to a set of weights relative to actual measured quantities of each.
Zero the quantity measurements that are below a configured threshold 409
Re-apply the calculated quantities to the feature set to build an estimated spectrum of identified materials and subtract 407 the estimate from the Filtered spectrum that is being analyzed.
The residual of the previous calculation is auto-correlated or some other method to estimate the likelihood that an additional signal is present 408.
   Advanced Peak Detection Method

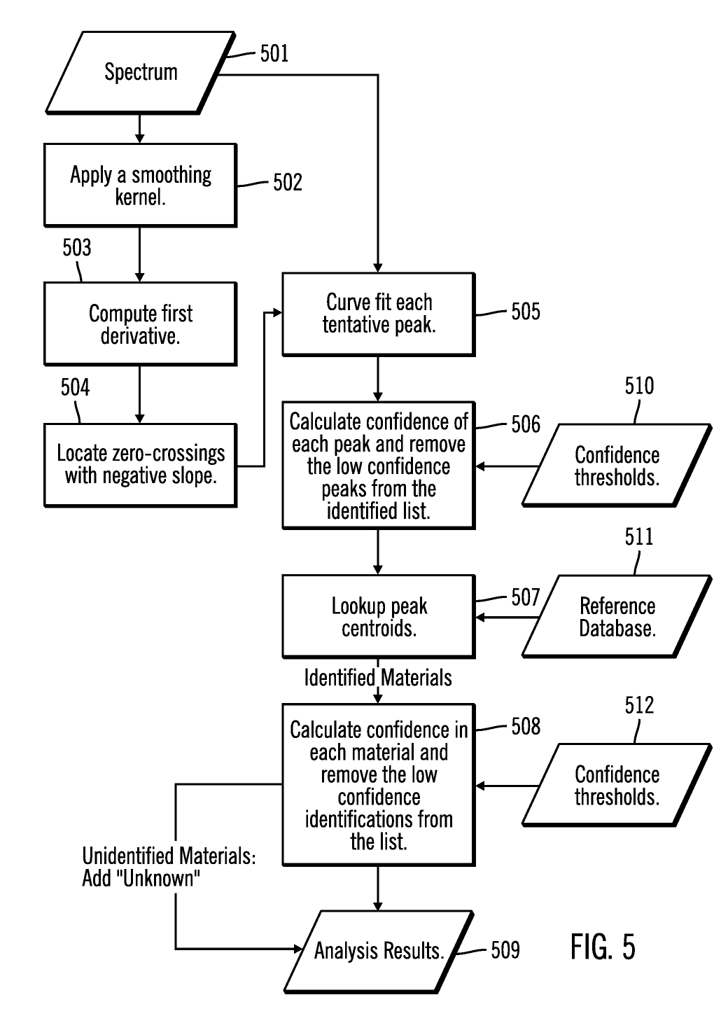

The Advanced Peak Detection (APD) method is used for a variety of applications that have both complex and distinct peaks for material detection, identification and quantification. FIG. 5 describes the process flow for the APD method. The description below utilizes isotope spectral analysis as an example of how the ADP method works.

There are two quite distinct reasons to do peak detection in gamma ray spectrum analysis. First, there is enough variability and drift in the spectrum measurement equipment to require frequent recalibration. We use a calibration source that produces two points—one at low energy and one at high energy. The low energy gamma rays are not spectrally resolvable but are intense enough to allow bias to be determined and maintained. The high energy peak (not actually from gammas but from alphas exciting the same detector that masquerade as gammas) is ideal for gain adjustment of that peak can be fit accurately. What we have are discrete signals in the right vicinity at discrete putative energies. We do not know what peak that corresponds to in terms of indicated energy. That is, the scale of energies is undetermined, and we do not have a definitive peak (Instead we have sampled values near the peak). If we did know the peak most likely to have led to those sampled values, we would thereby know what scale factor we need to be apply to make the indicated energy the proper value. We then apply that scale factor, fit the discrete data to a smooth curve (e.g. by a spline or a DOG) and resample at predetermined energies for subsequent analysis. Second, once the afore mentioned calibration has been done, it is important to ascertain the precise peak energy of any signal for purposes of identification and quantification.

The task is made more difficult by the fact that the system's energy point spread function (the indicated response curve for a monoenergetic gamma ray) varies with gamma ray energy. There is no fixed curve to fit. Because the response curves have multiple causes, we invoke the central limit theorem to suggest that they may be Gaussian in shape. Experimentally, that appears to be approximately correct. For calibration, consistency is more important than exact description in any case. So we tend to use a Gaussian shape. A Gaussian curve then has three parameters: A (a height adjusting factor), m (the mean energy of the curve), and σ (its standard deviation). It is σ that varies dramatically with energy. m is the peak value useful for the two purposes just discussed. A measures the amount of radiation present and is valuable in setting thresholds for detection and indicating the minimum amount of material present.

The first step in our preferred approach is to find some approximate fits. This can be done be convolution or correlation (fully identical operations for Gaussians) with Gaussians of different σ values, e.g. one each for low, medium, and high energy ranges. These can be thresholded to give possible starting fits—one for each real peak. Those Gaussians will be less than optimal fits, but the fits can be improved by iterative methods.

Alternative Pattern Recocinition Method: Here we describe one simple iterative improvement algorithm—a variant of gradient pursuit.

We begin with a figure of merit to be optimized. The least squares difference between the sample values S(Eᵢ) for a set of some preagreed number of points around the initially-indicated peak. Call that the basis set B. We can evaluate a Gaussian with parameters A, m, and σ at all points in B as well, whether that Gaussian be G_{A,m,σ}⁰ or some later improved estimate G_{A,m,σ}^{k}. At energy Eᵢ, there is a difference
dᵢₖ=S(Eᵢ)−G_{A,m,σ}^{k}(Eᵢ).

The sum of the squares of those differences over B can be called S and is the quantity we seek to minimize. Alternatively, we could calculate the cross correlation CC that is the product S(Eᵢ)G_{A,m, σ}^{k}(Eᵢ) summed over B. Maximizing CC obtains the identical result as minimizing the sum of the squares of the differences. For illustration, we discuss minimizing the sum of squared differences—a quantity we will call F (for figure of merit). Thus we seek changes in the parameters A, m, and σ that will drive F to the lowest possible value. (Note that always F≧0.)

If we use cross correlation, we should subtract twice the cross correlation from the sum of the autocorrelations to give a figure of merit whose value is always positive and would be 0 if the fit were perfect.

The initial fit gives an initial F we can call F₀. We want to change the parameters to drive F as close to 0 as possible. Let us make two incorrect but convenient assumptions:

F varies linearly with all three parameters

Each parameter should contribute a change −F/3 to the new value.

So how much should we change A, say, to change F by −F/3? We want the change in A to be ΔA such that
(∂F/∂A)ΔA=−F/3
or
ΔA=−F/[3(∂F/∂A)].
Unfortunately, we do not know the partial derivatives, so we make a small perturbation such as
∂/A=A/100
and see what change ∂F results. We then use
ΔA=−F∂A/3∂F
or
(ΔA)=−AF/[300(∂F)].

Similar approaches to changing the other two parameters are also made.

Applying those three changes in parameters simultaneously leads to a new Gaussian with a new value of F. This can be improved in the same manner.

This process continues until some stopping condition is met. For instance, we might quit after four rounds. Or, we might stop when the improvement effectively stops.

In FIG. 8, a process for peak detection is illustrated. In applications such as radiological isotope identification the key identifying feature in the collected data is a peak located in the data whose centroid is directly related to the original energy, wavelength, or other such value emitted or absorbed by the material. Due to noise or natural variations in the environment or electronics, these peaks can have varying shapes and resolution, and the exact value of the source is obscured. Also as the collection method may be frequency distributions or absorption values, there are random deviations in the intensity values related to collection time period or the random nature of the material being observed.

To assist identification of these materials we apply a process to ignore noise as much as possible and decompose the spectrum into known peak functions (such as Gaussian) that best represent the hardware capabilities of the detectors.

First the spectrum is smoothed to reduce localized random deviations from affecting the calculations and minimizing the number of tentative peaks that have to be evaluated. The smoothed spectrum is scanned for local maximums by using a discrete first derivative and locating the points where the first derivative function crosses the x-axis. These points are put into a list of tentative peaks that need further evaluation to be confirmed.

After building the tentative list of peaks, each peak is evaluated with a curve-fitting algorithm (such as our variation of gradient pursuit) of the expected peak function type (such as Gaussian). Peaks that do not converge during the fitting process and peaks that fit to values beyond expected ranges for the hardware or source are removed from the tentative list.

Each peak is then tested for confidence by using the properties of the collection method, such as Poisson statistics for gamma radiation. It is calculated how prominent the peak is above a baseline intensity, background intensity, and overlapping peaks intensity compared to the random deviations that can be expected from Poisson random probability. A threshold governs how strict the system is about confidence to balance false positives and false negatives to a value acceptable to the user.

Each verified peak is cross examined against a list of known materials by proximity to source value and confidence in measurement to identify possible sources, and then each possible source computed a confidence value that can be controlled by threshold to balance the false positives and false negatives to acceptable frequency. If anything results in a confident but unidentifiable peak a generic material is added to the identified analysis results whose strength is the total intensity of all unidentifiable sources.

It should be noted that the discussions of the embodiments of the invention can be applicable to any information processing system, for example, such as a personal computer, a workstation, or the like.

An information processing system, for example, includes a computer. The computer has a processor that is communicatively connected to a main memory (e.g., volatile memory), a non-volatile storage interface, a terminal interface, and a network adapter hardware. A system bus interconnects these system components. The non-volatile storage interface is used to connect mass storage devices, such as a data storage device to the information processing system. A data storage device can include, for example, a CD drive, which may be used to store data and/or program to and read data and/or program from a CD or DVD or floppy diskette (all not shown).

The main memory, in one embodiment, optionally includes the computer program instructions that implement the new methods as discussed above. Although these computer program instructions can reside in the main memory, alternatively these computer program instructions can be implemented in hardware and/or firmware within an information processing system.

An operating system, according to an embodiment, can be included in the main memory and can be a suitable multitasking operating system such as the Linux, UNIX, Windows XP, and Windows Server operating system. Various embodiments of the present invention can use any other suitable operating system, or kernel, or other suitable control software. Some embodiments of the present invention utilize architectures, such as an object oriented framework mechanism, that allows instructions of the components of operating system (not shown) to be executed on any processor located within the information processing system. The network adapter hardware is used to provide an interface to any communication network. For example, an Ethernet network can be used to communicate via TCP/IP communications. As another example, a wide area network, such as the internet, can be coupled to the network adapter hardware to allow communications via the internet.

While the exemplary embodiments of the present invention are described in the context of a fully functional computer system, those skilled in the art will appreciate that embodiments are capable of being stored and/or distributed as a program product via a computer readable medium, such as any one or more of the following: a floppy disk, a CD ROM, a DVD, a suitable memory device, a non-volatile memory device, any form of recordable media, or via any type of electronic transmission mechanism.

Although specific embodiments of the invention have been disclosed, those having ordinary skill in the art will understand that changes can be made to the specific embodiments without departing from the spirit and scope of the invention. The scope of the invention is not to be restricted, therefore, to the specific embodiments, and it is intended that the appended claims cover any and all such applications, modifications, and embodiments within the scope of the present invention.

What is claimed is:

1. A process of smoothing, resampling, and adaptive curve fitting to each peak initially indicated by some simpler curve fitting operation such as convolution of a spectrum with a peaked function such as a Gaussian or Lorentzian.

2. The process of claim 1, wherein the smoothing is done by convolution.

3. The process of claim 1, wherein the smoothing is done by curve fitting.

4. The process of claim 1, wherein a final curve fitting process for a specific peak is done by gradient descent or ascent, depending on whether a figure of merit is to be maximized or minimized.

5. The process of claim 1, wherein a final curve fitting for a specific peak is done by evolutionary methods.

6. The process of claim 1, wherein a final curve fitting for a specific peak is done by simulated annealing.

7. The process of claim 1, wherein a peak detection is used to identify a reference signal position for calibration of a detector used to provide the spectra for analysis.

8. A computer readable medium including software instructions for an information processing system, the software instructions comprising:
a sequence of software operations designed to identify and quantify the intensity of various isotopes contributing to an observed energy spectrum, where the sequence includes:
a preprocessing step that removes noise and minimizes the effects of Compton scattering;
followed by a fit of a resulting spectrum-derived signal as a linear sum of contributions from a prescribed set of isotopes and expected noise spectra; and
followed by an analysis of weights determined by a fit to determine whether an isotope should be reported and whether there may be need for one more stage in which effects from very high radiation levels are reduced and mistakes that nonlinearity can cause are mitigated.

9. The computer readable medium of claim 8, wherein a background subtraction normalizes a magnitude of subtracted spectrum according to a time taken to make a signal-plus-noise measurements.

10. The computer readable medium of claim 8, wherein a background subtraction normalizes a magnitude of subtracted spectrum according to a cross-correlation between a noise spectrum and a measured signal-plus-noise spectrum.

11. The computer readable medium of claim 8, wherein a Compton scattering mitigation process is implemented by differentiation of the observed energy spectrum.

12. The computer readable medium of claim 8, wherein a Compton scattering mitigation is implemented by differentiation of the observed energy spectrum followed by taking at least one of an absolute value of a differentiated signal and a function of an absolute value of a differentiated signal.

13. The computer readable medium of claim 8, wherein a Compton scattering mitigation is implemented by applying unsharp masking to the spectrum.

14. The computer readable medium of claim 8, wherein a Compton scattering mitigation is implemented by applying unsharp masking to the observed energy spectrum.

15. The computer readable medium of claim 8, wherein a Compton scattering mitigation is implemented by applying unsharp masking to the observed energy spectrum and taking at least one of an absolute value of an unsharp masking signal and the square of an absolute value of an unsharp masking signal.

16. The computer readable medium of claim 8, wherein a Compton scattering mitigation is implemented by applying convolution with an edge enhancing kernel such as the Sobel kernel to the observed energy spectrum.

17. The computer readable medium of claim 8, wherein a Compton scattering mitigation is implemented by applying smoothing before enhancing sharp lines.

18. The computer readable medium of claim 17, wherein the smoothing is done by convolution.

19. The computer readable medium of claim 17, wherein the smoothing is done by at least one of rank order filtering and median filtering.

20. The computer readable medium of claim 17, wherein the smoothing is done by convolution by mathematical morphology.

21. The computer readable medium of claim 8, wherein a curve fitting to isotopes and expected noise spectra occurs using Gram-Schmidt orthonormalization.

22. The computer readable medium of claim 8, wherein a curve fitting to isotopes and expected noise spectra occurs using Caulfield-Maloney orthonormalization.

23. The computer readable medium of claim 8, wherein the weights determined by curve fitting are thresholded at values designed to meet a false-positive versus false-negative decision criterion.

24. The computer readable medium of claim 8, wherein the weights are examined to determine if any are high enough to indicate a likely presence of a nonlinearity-induced error.

25. The computer readable medium of claim 24, wherein effects of any indicated nonlinearity on the weights are computed and subtracted to correct for the nonlinearity.

26. The computer readable medium of claim 24, wherein effects of any indicated nonlinearity are linearized by computing and subtracting corrections to the spectrum before an analysis of concentrations is done.

27. The computer readable medium of claim 8, wherein the sequence of software operations are used by the information processing system to detect, identify, and quantify any one or more of chemical, biological, radiation, nuclear, and explosive materials.

28. An information processing system including computer readable medium containing computer instructions comprising instructions for:
(a) a process of smoothing, resampling, and adaptive curve fitting to each peak initially indicated by some simpler curve fitting operation such as convolution of a spectrum with a peaked function such as a Gaussian or Lorentzian; and
(b) a sequence of software operations designed to identify and quantify the intensity of various isotopes contributing to an observed energy spectrum, where the sequence includes:
a preprocessing step that removes noise and minimizes the effects of Compton scattering;
followed by a fit of a resulting spectrum-derived signal as a linear sum of contributions from a prescribed set of isotopes and expected noise spectra; and
followed by an analysis of weights determined by a fit to determine whether an isotope should be reported and whether there may be need for one more stage in which effects from very high radiation levels are reduced and mistakes that nonlinearity can cause are mitigated, and
wherein both (a) and (b) are used as a dual confirmation method to enable greater accuracy.

29. The information processing system of claim 28, wherein both (a) and (b) are used to create greater accuracy by using (a) to optimize false negatives and (b) to further optimize false positives for an overall effect of reducing both false negatives and false positives.
